(19) United States
(12) Patent Application Publication
(10) Pub. No.: US 2003/0045311 A1
(43) Pub. Date: Mar. 6, 2003

(54) Message transfer from a source device via a mobile terminal device to a third device and data synchronization between terminal devices

(76) Inventors: Tapani Larikka, Vesilahti (FI); Jari Juopperi, Helsinki (FI)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/103,961

(22) Filed: Mar. 25, 2002

Related U.S. Application Data
(63) Continuation-in-part of application No. 09/941,851, filed on Aug. 30, 2001.

(51) Int. Cl. H04Q 7/20

(52) U.S. Cl. 455/466; 455/556; 455/557

(57) ABSTRACT

A technique for transferring a data message between a first terminal device and a second terminal device via an intermediate terminal device includes: entering a data message into the first terminal device; transmitting the data message from the first terminal device to the intermediate terminal device; formatting the data message into at least one SMS (Short Message Service) message in the intermediate terminal device; and transmitting the at least one SMS message from the intermediate terminal device to the second terminal device. Formatting the data message may include formatting the data in a SyncML format. The intermediate terminal device may include a mobile terminal and the data message may be transferred from the first terminal device to the intermediate terminal device via a short range communication link which may include an IR or Bluetooth communication link.

### CROSS-REFERENCE TO RELATED APPLICATIONS AND CLAIM OF PRIORITY:

The present application is a continuation-in-part of U.S. application Ser. No. 09/941,851, filed in the U.S. Patent and Trademark Office on Aug. 30, 2001 and priority is hereby claimed under 35 USC 120.

### BACKGROUND OF THE INVENTION:

1. Field of the Invention

The present invention relates to transferring of data synchronization messages between terminal devices. More particularly, the present invention relates to improvements in transferring SyncML (Synchronization Markup Language) messages from a source device to a destination device.

2. Description of the Related Art

Data synchronization between terminal devices is an issue in which each vendor has traditionally had their own proprietary solution. Each vendor developed their own synchronization protocol as well as internal data representations for each application. Due to the proprietary nature of such systems, the products of different vendors have been unable to communicate with each other without specially designed single purpose converters.

These non-interoperable solutions have complicated the tasks of users, manufacturers, service providers, and developers. Furthermore, the proliferation of different proprietary data synchronization protocols have placed barriers to the extended use of mobile terminals and has restricted data access and delivery and limited the mobility of the users.

In view of the above, several mobile terminal manufacturers joined together into an organization to create a new industry initiative to develop and promote a single, common, data synchronization protocol, namely, SyncML, that can be used everywhere, by every device or terminal and in every application. As noted on the Web site of the above-noted organization, www.syncml.org, SyncML is a common language which has been developed for synchronizing devices and applications over any network. SyncML leverages XML (Extensible Markup Language), that is, a SyncML message is an XML document, and with SyncML, network information can be synchronized with any mobile device or terminal and mobile information can be synchronized with any networked application or applications. With SyncML, any personal information, such as e-mail, calendars, to-do lists, contact information and other relevant data, etc., will be consistent, accessible, and up-to-date, no matter where the information is stored. For example, a calendar entry made to a mobile device or terminal on a business trip is equally available to a secretary in the network calendar.

At present, the SyncML standard contains three different transport alternatives for sending SyncML messages. These alternatives are HTTP (Hyper-Text Transfer Protocol), WSP (Web System Protocol), and OBEX (Object Exchange Protocol).

While each of these alternatives are usable, they all have the same defect, namely, all of these alternatives require the use of a continuous data connection between the mobile device or terminal and the network.

Furthermore, there is no presently available menu based configuration utility for entering data to be synchronized in a mobile terminal device having a display.

Still furthermore, there are personal portable server devices presently available which only have short range connection capabilities, such as IR (Infrared) or Bluetooth. Accordingly, at present, they are unable to synchronize data with remotely located terminals which are out of their limited communication range.

### SUMMARY OF THE INVENTION

In view of the above, it was felt desirable to find a different transport mechanism which could also be used with the SyncML standard but which did not require the use of a continuous data connection between the mobile device or terminal and the network.

Modern-day mobile terminals, such as mobile telephones, have been provided with the SMS (Short Message Service) capability. SMS allows a single short message of up to one hundred sixty characters of text in length to be sent from a sender to a recipient. However, rather than requiring a continuous data connection, the SMS is a store and forward service, that is, short messages are not sent directly from sender to recipient but rather are sent via an intermediary SMS center instead. Each mobile telephone network that supports SMS, for example, has one or more SMS messaging centers to handle and manage SMS messages. Many such modern-day mobile terminals include IR or Bluetooth capability which allows them to communicate with the aforementioned personal portable servers.

Accordingly, it is an object of the present invention to utilize the short range communication capability of a mobile device or terminal device as a transport mechanism to forward SyncML messages from a source device or terminal device to another terminal device.

The above-noted object may be effected by providing a method of synchronizing data between first and second terminal devices, the method including: obtaining data to be synchronized in the first terminal device; formatting the data to be synchronized into at least one SMS message in the first terminal device; and transmitting the at least one SMS message from the first terminal device to the second terminal device.

Furthermore, as noted above, there is no presently available menu based configuration utility for entering data to be synchronized in a mobile terminal device having a display. Accordingly, it is another object of the present invention to provide a method of entering data to be synchronized in the mobile terminal device having a display.

The above-noted object may be effected by providing a method of entering data to be synchronized in a mobile terminal device having a display, the method including: displaying a first menu on the display, the first menu having options to be selected by the user, the options including the entering of a SyncML message; upon the selection of the entering of a SyncML message by the user, displaying a second menu on the display, the second menu having options to be selected by the user including the execution of a SyncML message; upon the selection of the execution of a SyncML message by the user, displaying a third menu on the display, the third menu having options to be selected by the user including addresses of destinations to which the synchronizing data is to be sent and another option of line the user to entering new address; and upon the selection of an interest by the user or the entry of a new address by the user, displaying a fourth menu and the display, the fourth menu prompting the user to enter the data to be synchronized as the SyncML message and displaying the data entered by the user.

The above-noted objects may also be effected by providing a method of synchronizing data between first and second terminal devices, the method comprising the steps of: obtaining data to be synchronized in a first terminal device; formatting the data to be synchronized into a synchronization format; inserting the formatted data to be synchronized into at least one messaging transport protocol message in the first terminal device including identifiers associated with the synchronization format; and transmitting the at least one messaging transport protocol message including identifiers associated with the synchronization format from the first terminal device to a second terminal device via a mobile network.

Furthermore, the above-noted objects may also be effected by providing a mobile terminal device, comprising: a means for obtaining data to be synchronized; a SyncML module for formatting the data to be synchronized into a SyncML format; a means for inserting the formatted data to be synchronized into at least one messaging transport protocol message; and a transmitter to transmit the at least one messaging transport protocol message to another terminal device.

Still furthermore, the above-noted objects may also be effected by providing a medium, executable in a computer system, for synchronizing data between first and second terminal devices, comprising: program instructions for obtaining data to be synchronized in the first terminal device; program instructions for formatting the data to be synchronized into a synchronization format; program instructions for inserting the formatted data to be synchronized into at least one messaging transport protocol message in the first terminal device including identifiers associated with the synchronization format; and program instructions for transmitting the at least one messaging transport protocol message including identifiers associated with the synchronization format from the first terminal device to the second terminal device via a mobile network.

Lastly, the above-noted objects may also be effected by providing a system for synchronizing data between first and second terminal devices, comprising: a first terminal having means for obtaining data to be synchronized and a short-range transceiver for transmitting the data to be synchronized via a short-range communication link; an intermediate terminal device having a short-range transceiver for receiving said data to be synchronized, the intermediate terminal further comprising: a module for formatting the data to be synchronized into a synchronization format; means for inserting the formatted data to be synchronized into at least one messaging transport protocol message including identifiers associated with the synchronization format; and a transmitter for transmitting the at least one messaging transport protocol message including identifiers associated with the synchronization format via a mobile network; an intermediate gateway capable of receiving the at least one messaging transport protocol message and forwarding the data to be synchronized to a destination; and a second terminal device capable of receiving the data to synchronized and executing the data to be synchronized.

### BRIEF DESCRIPTION OF THE DRAWINGS

The foregoing and a better understanding of the present invention will become apparent from the following detailed description of example embodiments and the claims when read in connection with the accompanying drawings, all forming a part of the disclosure of this invention. While the foregoing and following written and illustrated disclosure focuses on disclosing example embodiments of the invention, it should be clearly understood that the same as by way of illustration and example only and that the invention is not limited thereto. The spirit and scope of the present invention are limited only by the terms of the appended claims.

The following represents brief descriptions of the drawings, wherein:

FIG. 1 is a block diagram illustrating an example of a system to which the present invention may be applied.

FIG. 2 illustrates a SyncML message being inserted into an SMS message in accordance with an example embodiment of the present invention.

FIG. 3 illustrates a SyncML message being split up and inserted into a plurality of SMS messages in accordance with an example embodiment of the present invention.

FIG. 4 illustrates a functional representation of one embodiment of a mobile terminal embodying the present invention.

FIG. 5 and FIG. 6 together illustrate an example of how data synchronization may be effected in a mobile terminal in accordance with an embodiment of the present invention.

FIG. 7 illustrates an example of an original SyncML message.

FIG. 8 illustrates an example of the original SyncML message split into three SMS messages by a mobile terminal in accordance with an embodiment of the present invention.

FIG. 9 illustrates another example of a system to which the present invention may be applied.

### DETAILED DESCRIPTION

Before beginning a detailed description of the subject invention, mention of the following is in order. When appropriate, like reference numerals and characters may be used to designate identical, corresponding, or similar components in differing drawing figures. Furthermore, in the detailed description to follow, example sizes/model/values/ranges may be given, although the present invention is not limited thereto. Where specific details are set forth in order to describe example embodiments of the invention, it should be apparent to one skilled in the art that the invention can be practiced without, or with variations of, these specific details. Finally, it should be apparent that differing combinations of hard-wired circuitry and software instructions can be used to implement embodiments of the present invention, that is, the present invention is not limited to any specific combination of hardware and software.

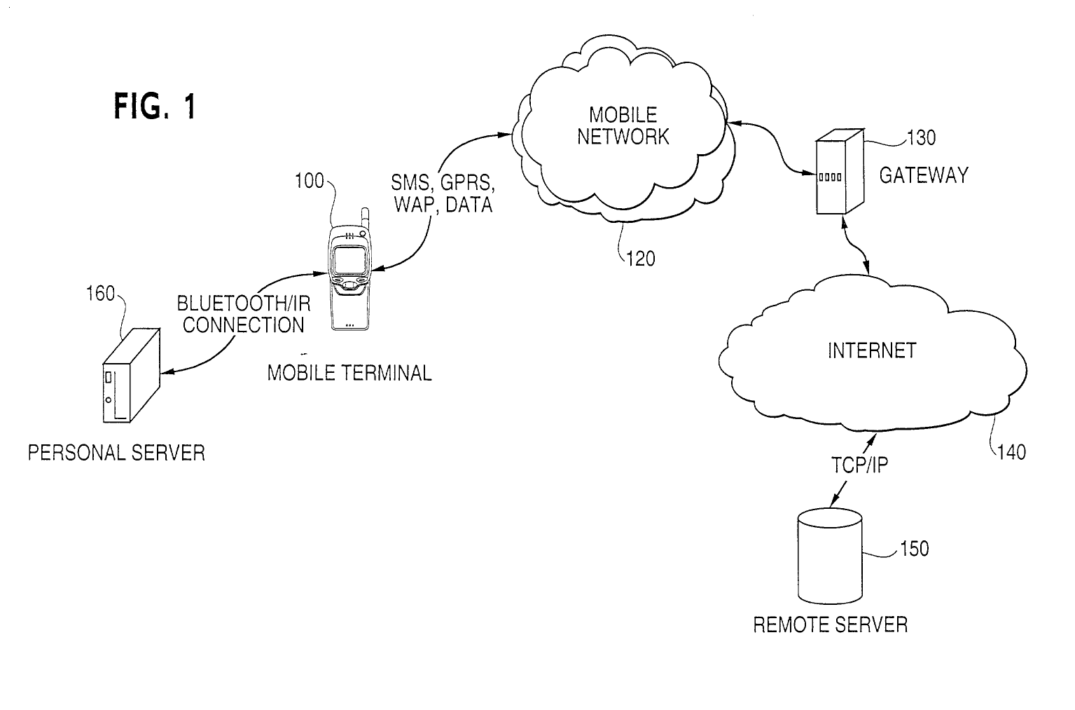

FIG. 1 is a block diagram illustrating an example of a system to which the present invention can be applied. As illustrated in FIG. 1, a mobile terminal 100, such as a cell phone, is connected to a mobile network 120 such that data in various formats, e.g.-SMS, MMS, GPRS, WAP, UMTS, may be transmitted therebetween. The mobile network 120 is connected to an another network, such as the Internet 140 through a gateway 130. Accordingly, the mobile terminal 100 may communicate with the remote server 150 bi-directionally via the mobile network 120, gateway 130, and Internet 140. A personal server 160, for example, may be connected to the mobile terminal 100 via a short-range connection such as Bluetooth or IR.

Thus, the mobile terminal 100 may operate in effect as a modem, or as a data adapter for the personal server 160 so as to allow the personal server 160 to forward messages, such as data to be synchronized, to the remote server 150 via the mobile network 120 and gateway 130 and Internet 140.

As mentioned previously, the widespread use of mobile terminal devices has increased demand for a technique for synchronizing such mobile terminal devices with both other mobile terminal devices and fixed terminal devices. For example, a salesman who is away from his office may wish to update his calendar and business contacts address book on his mobile terminal device and to then update, that is, synchronize, his calendar and business contacts address book on his office computer. He may also wish to synchronize his calendar on his office network so that his secretary and his supervisor can be aware of his schedule.

As also mentioned previously, modern-day mobile terminals are now being provided with SMS (Short Message Service) capability. SMS allows a sender to send a short message to a recipient via an SMSC (Short Message Service Center). To use the SMS service, a user needs a subscription to a mobile telephone network that supports SMS. In addition, the use of SMS must be enabled for that user, for example, automatic access to the SMS is provided by some mobile network operators while others charge a monthly subscription to use the service. The user would require a mobile terminal that supports sending of messaging transport protocol messages, such as SMS messages and a knowledge of how to send or receive an SMS message on that mobile terminal. What is meant by the term “messaging transport protocol message” is that the message to be sent is sent using any of the available messaging protocols. When using messaging protocols, such as, for example, SMS or MMS, there does not have to be a continuous data connection between the sender and the recipient. Lastly, the user must know a destination to send the message to. More information relating to SMS can be found in various GSM standards, for example, from 3GPP (3^{rd} Generation Partnership Project) organization pages: http://www.3gpp.org.

As noted above, the SyncML standard presently contains three different transport alternatives for sending SyncML messages, namely, HTTP, WSP, and OBEX. All these alternatives require the use of a continuous data connection between the mobile terminal and the telephone network.

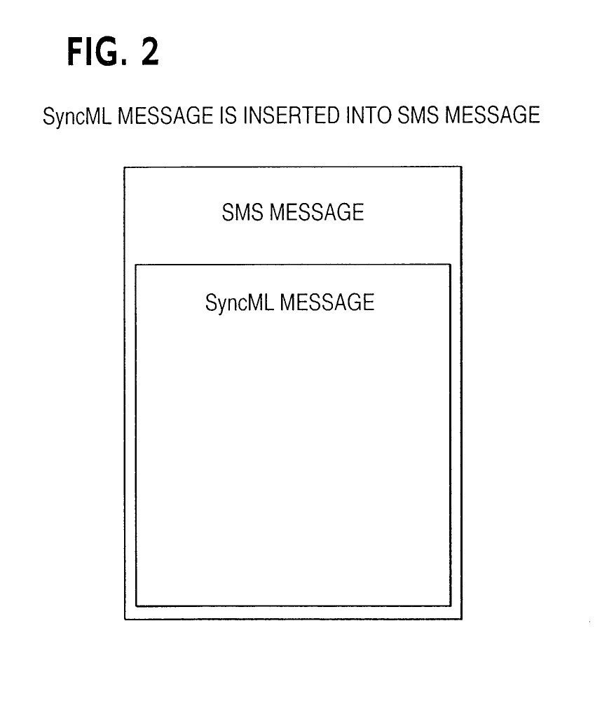

On the other hand, according to one embodiment of the present invention, it is proposed that a fourth transport alternative to be provided for sending SyncML messages namely, the SMS network. As shown in FIG. 2, it is proposed that the SyncML message of a user be inserted into an SMS message and sent to a recipient via the SMS network. Since modern-day mobile terminals already include SMS capability and since SMS centers are already in place and operating, no new technology or equipment is needed to send SyncML messages via the SMS network.

Furthermore, since SMS is a store and forward service, short messages are not sent directly from the sender to the recipient via a continuous data connection but rather are sent via an SMS center instead. This increases the reliability and reduces the operating costs.

The only disadvantage of using SMS is that a single SyncML message is limited to one hundred and sixty characters. However, the use of WBXML (Wireless Application Protocol Binary Extensible Markup Language) encoding allows for a compact binary representation of XML (Extensible Markup Language), allowing more effective use of XML data on narrowband communication channels, thereby allowing a SyncML message to possibly be reduced in size so as to fit within the size limitation of the SMS message. Furthermore, other data compression techniques could also be used to reduce the size of a SyncML message.

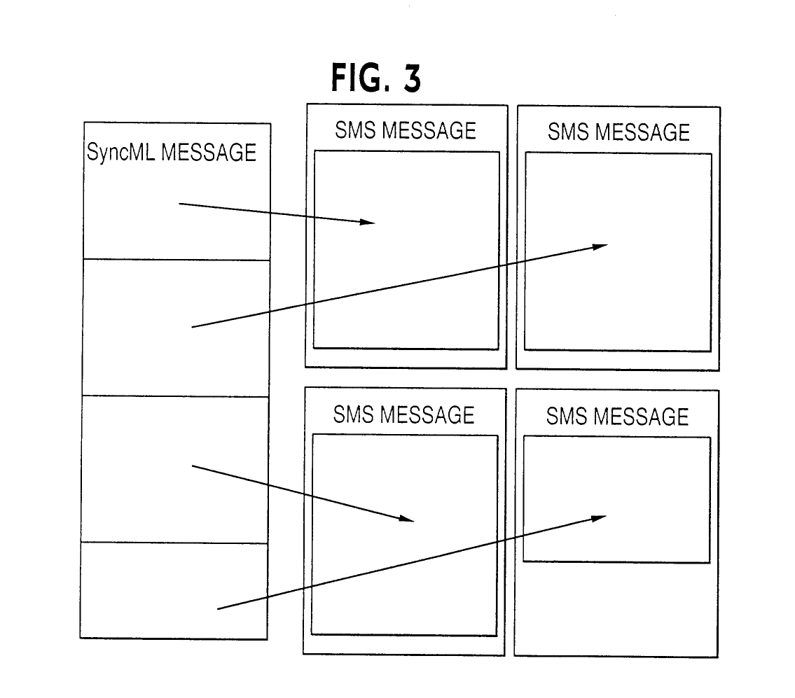

Furthermore, should it be impossible to limit the SyncML message to one hundred and sixty characters, as illustrated in FIG. 3, it is possible to split a SyncML message into two or more portions and transmit the SyncML message using two or more SMS messages. It is noted that current SMS standards provide for sending multiple short messages, which are to be combined by the recipient. Also terminals, such as Nokia 33xx and Nokia 92xx series support this combining of received messages into a single message.

It is also to be noted that the SyncML standard includes two different mandatory MIME (Multipurpose Internet Mail Extension) types, namely, vcal, a format for synchronizing calendars and vcard, a format for synchronizing business cards (that is, a business contact address book). This allows for further standardization between terminals of different manufacturers. Other MIME types are presently not supported nor requested, thus basically reducing the use of SyncML for only these two MIME types. More information about MIME can be found in RFC2045-RFC2049. These RFCs may be found on the Internet Web site: www.nacs.uci.edu/indiv/ehood/MIME/MIME.html, among others.

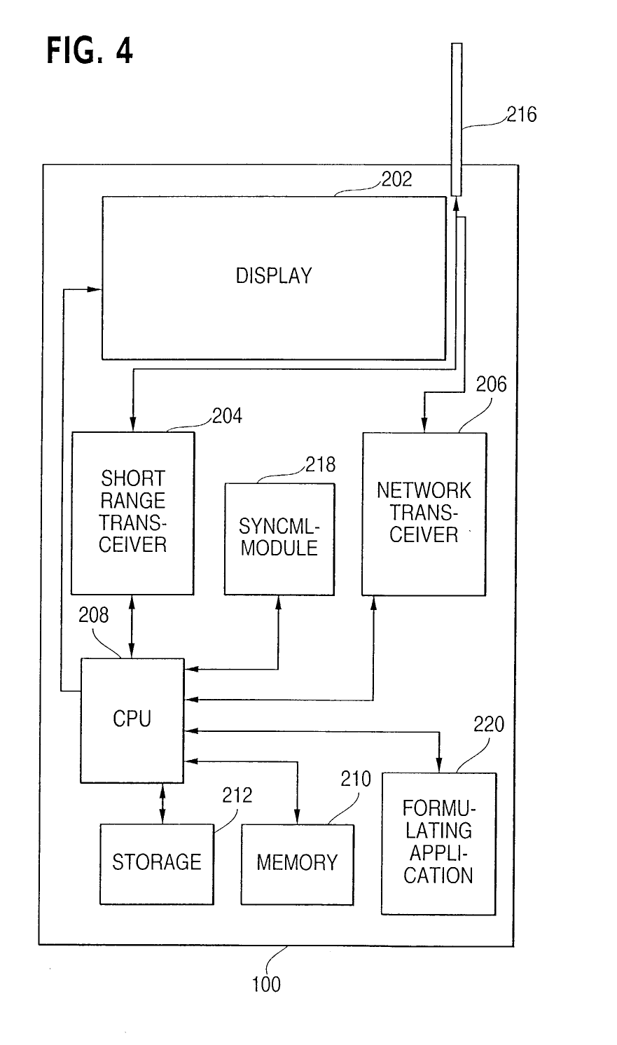

According to one embodiment of the present invention, the mobile terminal 100 embodying the invention illustrated in FIG. 4 is provided with a SyncML module 218 capable of recognizing received SyncML messages regardless of the bearer type. The module can be implemented in the terminal 100 with a dedicated circuitry or with a software and is capable of recognizing received SyncML messages regardless of the bearer as long as the used bearer (e.g. LPRF or SMS) uses a specific MIME type indication, such as for example “application/vnd.syncml+xml” or “application/vnd.syncml+wbxml” and as long as there is an identifier in the beginning of the message, such as <SyncML xmls=‘SYNCML: SYNCML1.0’>, for example. The terminal 100 includes also a CPU 208, a memory 210 and a storage 212 connected to it, as well as the SyncML module 218, and a network transceiver module 206 enabling the terminal to communicate with the mobile network 120, and a short range transceiver module 204 enabling short range connectivity with other devices, such as for example the personal server 160. The mobile terminal 100 is also capable of formatting the received content by the short-range communication format, such as LPRF or IR to a suitable format for communication with mobile network 120, such as GSM or GPRS, and vice versa, which is already known in the art.

The mobile terminal 100 may send the synchronized data automatically after receiving it or may buffer the data into storage 212 and send it later either automatically or manually depending upon the option set by the user of the mobile terminal 100.

There are two options available with regard to sending synchronization messages from the personal server 160, namely, the server 160 creates the entire SyncML message and the mobile terminal 100 just formats the message into the correct format and sends it to the mobile network 120 or alternatively, the server 160 informs the mobile terminal 100 that it needs synchronization services and after receiving the content of the message, the mobile terminal 100 creates the actual SyncML message or messages to send to the network 120.

For allowing a user of a mobile terminal to easily create and send SyncML messages using a messaging transport protocol, such as, for example SMS as a bearer, the terminal may also include a formulating application 220, which is connected to the CPU 208 and to user interface including a display 202, and input and audio output devices such as a key set and a speaker (not shown in the figure). The formulating application 220 allows the user to create a SyncML message by just inputting the content of the message, and SyncML identifiers and other SyncML coding is added by the formulating application 220 along content. In other words, the user can create a SyncML message in his terminal by selecting a SyncML message-mode via the user interface and inputting just preferred content (SyncML commands) as like typing a conventional SMS message, and after the SyncML message content is completed, the formulating application adds all necessary identifiers and coding along the content the message can be sent.

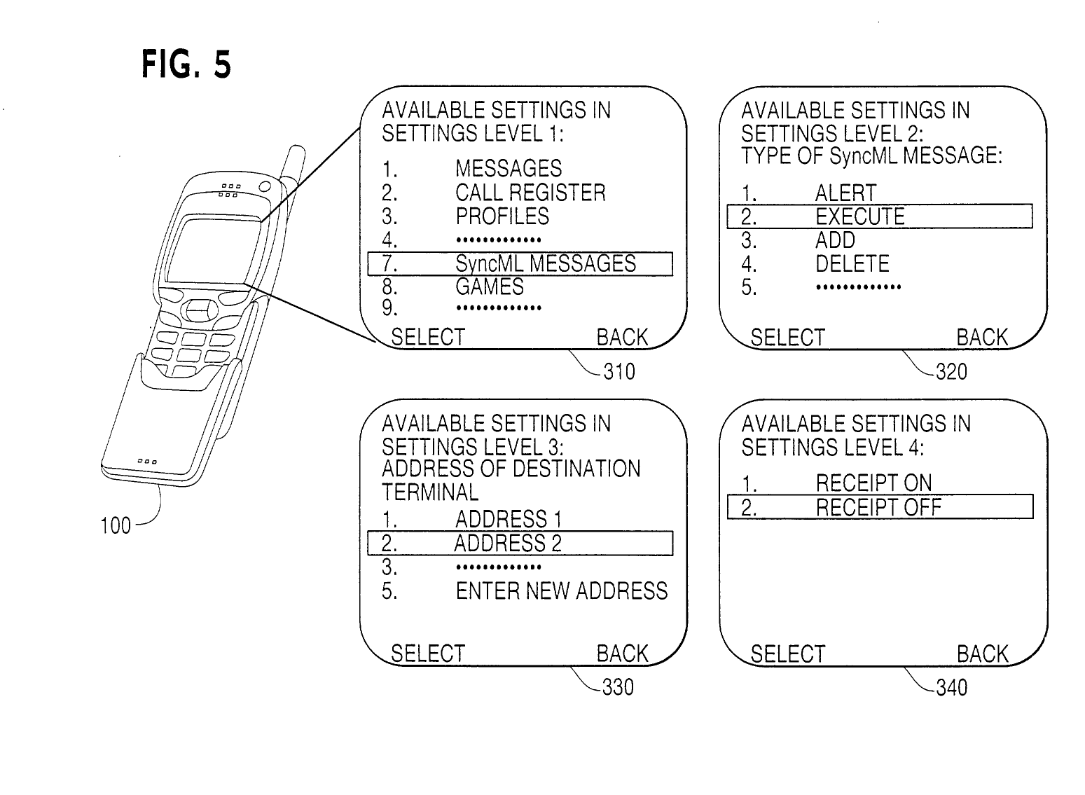

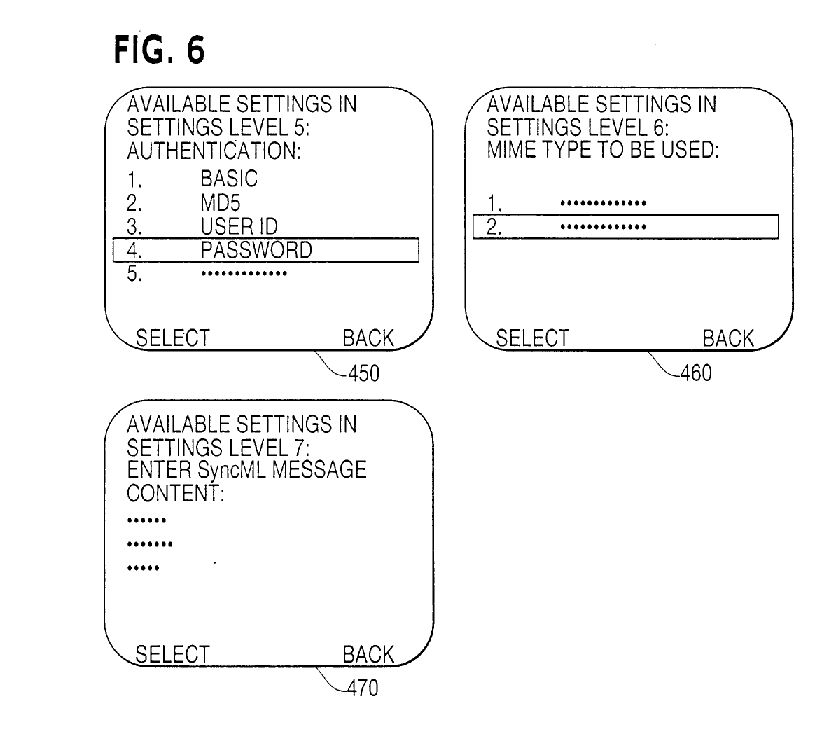

FIGS. 5 and 6 illustrate an example of how data synchronization message may be effected in a mobile terminal in accordance with an embodiment of the present invention using the formulating application 220. As shown in FIGS. 5 and 6, the mobile terminal 100 has seven different screens, numbered 310, 320, 330, 340, 450, 460, and 470 which the user may go through, when attempting to create a synchronization message. When the user sees screen 310, the user selects option number 7, namely, SyncML to create and send a SyncML message. Upon the user's selection of option number 7 of screen 310 the formulating application 220 is activated and the user is then prompted with screen 320 allowing the user to select the message type to be used. For example, the user selects option number 2, namely, Execute. Upon the user selecting the Execute option of screen 320, the user is then provided with screen 330 asking the user to determine destination address. The user can select one of the addresses already stored in the mobile terminal or alternatively type in a new address. Upon the user typing in a new address, the user is asked if this new address should be stored as a new address in the SyncML addresses (not shown). For example, it is assumed that the user selects option number 2, namely, Address 2 of screen 330. The user is then asked in screen 340 to select either Receipt on or Receipt off, which determines whether the destination device is instructed to send back an acknowledgement that a message has been received and a command within the message fulfilled. In screen 450 of FIG. 6, the user is asked to select the proper authentication method and finally, in screen 460, the user is asked to select the MIME type to be used. After making the selection of the suitable MIME type in screen 460, the user can type the contents of the SyncML message in screen 470 and the formulating application 220 adds to the message all necessary identifiers and other information based on users selections.

In the gateway 130, several messages can be “chained” into a single TCP/IP packet using the same principles as with the mobile terminal 100 combining several SMS messages into one message. This is possible, because in every SyncML message, the message begins with the identifier <SyncML> and the end of the SyncML message is indicated by the identifier </SyncML> according to current SyncML specifications and these indicators can be used to inform the gateway 130 that the message has started or ended and the gateway can stack and strip received and stored SMS messages in between the indicators into one single SyncML message and format it into a single TCP/IP packet and send the TCP/IP packet to the given destination. Alternatively, the SMS training may inform the gateway 130 to stack the right messages into a TCP/IP packet. Note that this may be performed also in the opposite direction. Also several TCP/IP packets can be used. PCT Application No. WO 01/17281, which is incorporated herein in its entirety, discloses in detail a gateway system providing communication between mobile network terminals and the Internet.

When an SMS message including a SyncML message is received by the mobile terminal 100 from the mobile network 120, the SyncML recognition is performed by the SyncML module 218, as noted above. After receiving all SMS messages from the network 120, the mobile terminal 100 stores the received SMS messages in storage 208 and formats the content into a suitable packet and changes the bearer into Bluetooth, for example, for sending the messages to the personal server 160.

As noted above, provision is made for sending SyncML messages in excess of the one hundred and sixty character limitation of single SMS messages. This may be automatically provided for by the SMS programming in the mobile terminal. Alternatively, the SyncML message may be transmitted by one of the other three available transport alternatives, namely, HTTP, WSP, and OBEX, or any other available transport alternative.

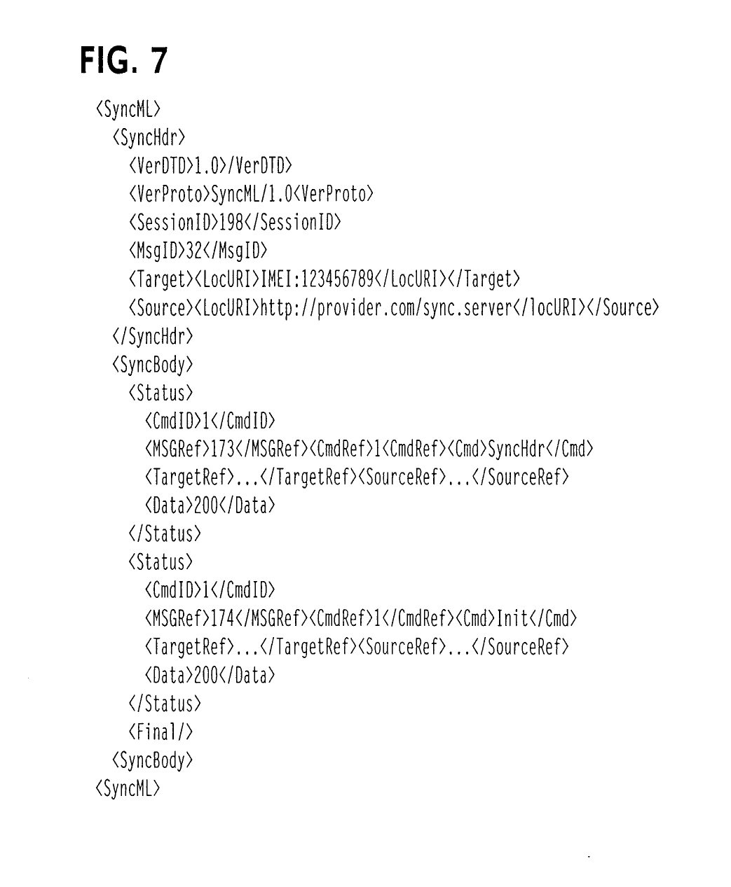

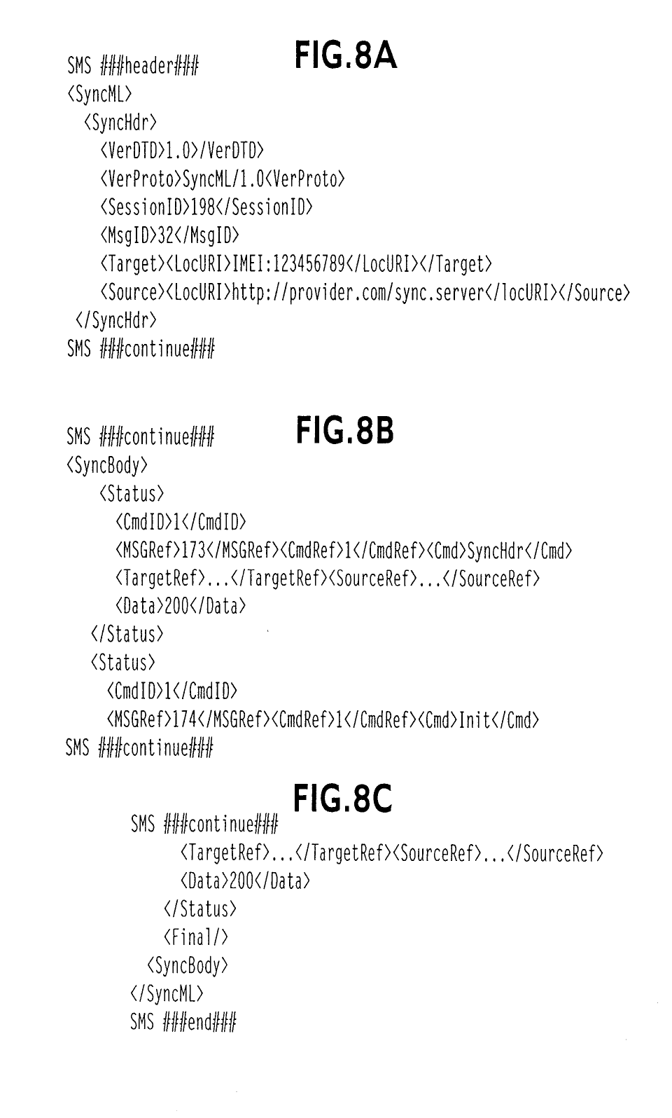

FIG. 7 illustrates an example of an original SyncML message while FIG. 8 illustrates an example of the original SyncML message of FIG. 7 after being split into three SMS messages by a mobile terminal, for example, in accordance with an embodiment of the present invention. It should be noted that the SyncML message illustrated in FIG. 7 and the SyncML messages illustrated in FIG. 8 have been made easier to read by the addition of line spacings. These line spacings are not needed and may be omitted from the actual SyncML messages. Furthermore, indicators, such as SMS###Continue### in these exemplary SMS messages are not according to SMS standards but rather have been added for reference purposes. Still furthermore, the characters of the SMS messages have not been counted to be within 160 characters. However, as has been noted previously, the reason for actually splitting a SyncML message into two or more SyncML messages is the fact that an SMS message cannot exceed 160 characters.

According to yet one embodiment of the present invention, another messaging transport protocol, namely Multimedia Messaging Service (MMS) can be used as an alternative bearer for sending a SyncML message from the mobile terminal 100 to a destination via mobile the network 120. MMS is the next evolutionary step from SMS. For a user perspective, MMS system works similarly to SMS. However, MMS provides the opportunity to utilize a wide variety of richer content types than SMS and because MMS uses data traffic channels instead of signalling it is well suited to deliver substantially larger contents (transport capacity in the area of 30 kilobytes) allowing the whole SyncML message being sent with just one MMS message even in the cases where the message exceeds 160 characters. MMS also allows direct messaging between mobile devices and WEB applications and the Internet, and messaging between different network technologies (e.g. GSM, 3G, TDMA and CDMA) is feasible making MMS an adaptive and truly global service. So, it is proposed, according to one embodiment of the present invention, that MMS messages can also be utilized for sending SyncML messages and MMS to be added as a fifth transport alternative to be provided for sending SyncML messages. The MMS and its overall concepts have been standardized in 3GPP. WAP 2.0 released in July 2001. The MMS standards are composed of three documents: WAP-205-MMSArchOverview,WAP forum; WAP-206-MMSCTR, WAP forum; and WAP-209-MMSEncapsulation, WAP forum, which all can be found on the Internet at http:/www.wapforum.org.

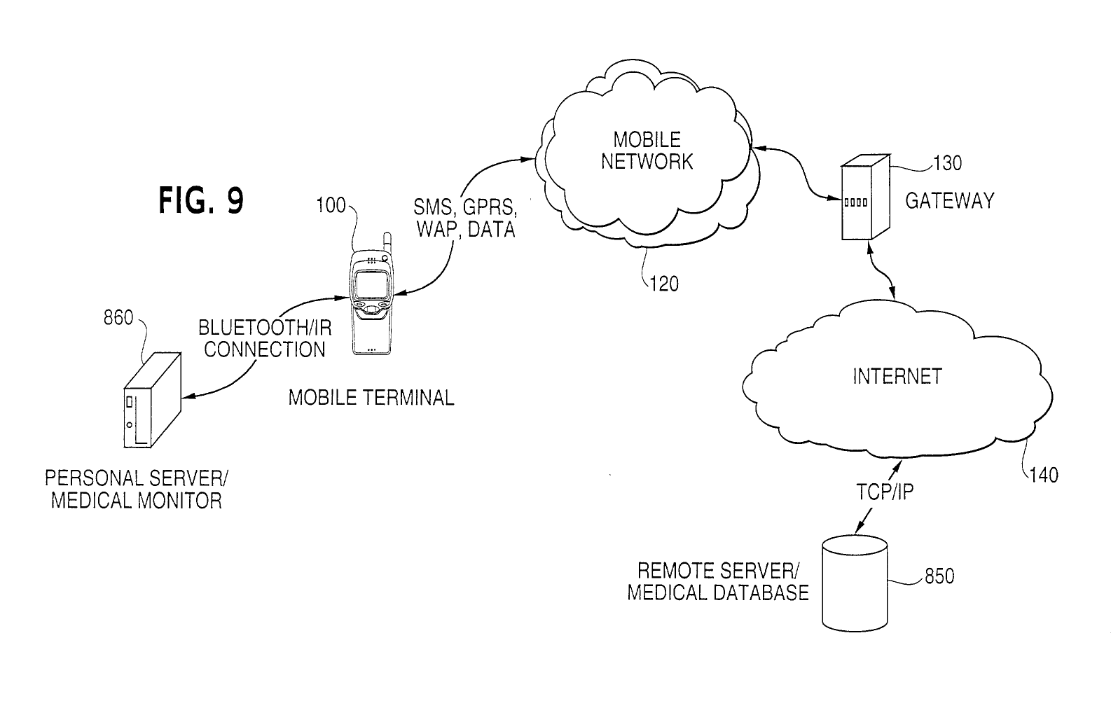

FIG. 9 illustrates another example of a system to which the present invention may be applied. As illustrated in FIG. 9, the personal server 160 has been replaced by another personal server 860 which includes a medical monitoring device for monitoring medical conditions of the user of the mobile terminal 100. In addition, as illustrated in FIG. 9, the remote server 150 has been replaced by another remote server 850, which includes the user's health statistic database.

The medical monitoring device included in the personal server 860 may include, for example, a heart monitor or respiration monitor or blood pressure monitor or pulse monitor or temperature monitor or any combination thereof. When an elderly user wishes to check his blood pressure, which could be done on a regular basis such as twice a day, the blood pressure monitor measures the blood pressure of the elderly user and sends the results automatically via the mobile terminal 100 to the health statistic database included in the remote server 850. The database may then be accessed by the doctor of the elderly user, with his permission, so as to allow the doctor to monitor the user's health.

Accordingly, by the use of this system, the elderly user is relieved of the duty to send the measurement results manually by entering the measurement results into the mobile terminal 100 via and SMS message. Rather, the health statistic database of the user is automatically updated.

This concludes the description of the example embodiments. Although the present invention has been described with reference to a number of illustrative embodiments thereof, should be understood that numerous other modifications and embodiments can be devised by those skilled in the art that will fall within the spirit and scope of the principles of this invention. More particularly, reasonable variations and modifications are possible in the component parts and/or arrangements of the subject combination arrangement within the scope of the foregoing disclosure, the drawings, and the appended claims without departing from the spirit of the invention. In addition to variations and modifications in the component parts and/or arrangements, alternative uses will also be apparent to those skilled in the art.

Furthermore, the specific details of the SMS protocol, SyncML protocol, WBXML, and MIME protocol have not been included in the present specification for the sake of brevity. It is understood that these industry wide protocols are readily available and the details thereof are incorporated by reference herein in their entirety.

What is claimed is:

1. A method of synchronizing data between first and second terminal devices, the method comprising the steps of:
obtaining data to be synchronized in a first terminal device;
formatting the data to be synchronized into a synchronization format;
inserting the formatted data to be synchronized into at least one messaging transport protocol message in the first terminal device including identifiers associated with the synchronization format; and
transmitting the at least one messaging transport protocol message including identifiers associated with the synchronization format from the first terminal device to a second terminal device via a mobile network.

2. The method of claim 1, wherein the step of obtaining the data to be synchronized in the first terminal comprises entering the data to be synchronized by a user of the first terminal device.

3. The method of claim 2, further comprising the steps of:
displaying to the user of the first terminal device a set of selection options associated with formatting a synchronization message;
prompting the user of the first terminal device to input a content of the data to be synchronized; and
upon user selection of the options and completing the inputting of the content of the data to be synchronized, formatting the data to be synchronized into the synchronization format according to said user selection of the options.

4. The method of claim 3, wherein the set of selection options comprises selections associated with at least one of a destination address, a message type, a message format, authorization information, a receipt instruction and a MIME (Multipurpose Internet Mail Extension) type.

5. The method of claim 1, wherein the identifiers associated with the synchronization format includes at least one identifier associated with a SyncML format and wherein the data to be synchronized is formatted according to the SyncML format.

6. The method of claim 1, wherein the at least one transmitted messaging transport protocol message includes at least one identifier associated with a beginning of a SyncML message.

7. The method of claim 1, wherein the at least one transmitted messaging transport protocol message includes at least one identifier associated with a continuation of a SyncML message.

8. The method of claim 1, wherein the at least one transmitted messaging transport protocol message includes at least one identifier associated with an ending of a SyncML message.

9. The method of claim 1, wherein the step of transmitting the at least one messaging transport protocol message including identifiers associated with the synchronization format from the first terminal device to the second terminal device via a mobile network further comprises the steps of:
transmitting the least one message from the first terminal device to a message center; and
transmitting the at least one message from the message center to the second terminal device.

10. The method of claim 1, wherein the at least one transmitted messaging transport protocol message comprises an SMS (Short Message Service) message.

11. The method of claim 10, wherein the at least one transmitted SMS message comprises at least one compressed SMS message.

12. The method of claim 11, wherein the at least one compressed SMS message comprises a WBXML (Wireless Application Protocol Binary Extension Markup Language) coded message.

13. The method of claim 1, wherein the first terminal device comprises a mobile handheld terminal.

14. The method of claim 13, wherein the mobile handheld terminal comprises a mobile phone.

15. The method of claim 1, wherein the second terminal device comprises a mobile handheld terminal.

16. The method of claim 15, wherein the mobile handheld terminal comprises a mobile phone.

17. The method of claim 10, wherein the second terminal device comprises a server connected to the Internet and wherein the at least one transmitted SMS message is transmitted to the server through a gateway.

18. The method of claim 17, further comprising the steps of:
receiving the at least one transmitted SMS message at the gateway;
stacking and stripping the at least one received SMS message into a single SyncML message by the gateway; and
formatting the single SyncML message into a TCP/IP format prior sending the message to the server.

19. The method of claim 18, further comprising the step of executing the data to be synchronized of the received single SyncML message by the server.

20. The method of claim 19, further comprising the step of sending an acknowledge message back to the first terminal device upon execution of the data to be synchronized.

21. The method of claim 10, further comprising the steps of:
receiving the at least one transmitted SMS message at the second terminal device;
storing the at least one received SMS message by the second terminal device; and
stacking and stripping the at least one stored SMS message into a single SyncML message by the second terminal device.

22. The method of claim 21, further comprising the step of executing the data to be synchronized of the single SyncML message by the second terminal device.

23. The method of claim 21, further comprising the steps of:
formatting the single SyncML message into a short range communication protocol format by the second terminal device; and
transmitting the single SyncML message via a short-range communication protocol link to a third terminal device communicating with the second terminal device.

24. The method of claim 23, wherein the short-range communication protocol link comprises a Bluetooth link conforming the principles of Bluetooth technology.

25. The method of claim 23, wherein the short-range communication protocol link comprises an infrared link.

26. The method of claim 23, further comprising the step of executing the data to be synchronized of the received single SyncML message by the third terminal device.

27. The method of claim 23, wherein the third terminal device comprises a personal server.

28. The method of claim 1, wherein the at least one transmitted messaging transport protocol message comprises an MMS (Multimedia Message Service) message.

29. The method of claim 28, wherein the second terminal device comprises a server connected to the Internet and wherein the transmitted MMS message is transmitted to the server through a gateway.

30. The method of claim 29, further comprising the step of executing the data to be synchronized of the received single MMS message by the server.

31. The method of claim 30, further comprising the step of sending an acknowledge message back to the first terminal device upon execution of the data to be synchronized.

32. The method of claim 28, further comprising the steps of:
receiving the transmitted MMS message at the second terminal device;
storing the received MMS message by the second terminal device; and
stripping the stored MMS message into a single SyncML message by the second terminal device.

33. The method of claim 32, further comprising the step of executing the data to be synchronized of the single SyncML message by the second terminal device.

34. The method of claim 32, further comprising the steps of:
formatting the single SyncML message into a short range communication protocol format by the second terminal device; and
transmitting the single SyncML message via a short-range communication protocol link to a third terminal device communicating with the second terminal device.

35. The method of claim 34, wherein the short-range communication protocol link comprises a Bluetooth link conforming the principles of Bluetooth technology.

36. The method of claim 34, wherein the short-range communication protocol link comprises an infrared link.

37. The method of claim 34, further comprising the step of executing the data to synchronized of the received single SyncML message by the third terminal device.

38. The method of claim 34, wherein the third terminal device comprises a personal server.

39. The method of claim 1, wherein the step of obtaining the data to be synchronized in the first terminal comprises receiving a short-range communication protocol message via a short-range communications link.

40. The method of claim 39, wherein the short-range communication protocol link comprises a Bluetooth link conforming the principles of Bluetooth technology.

41. The method of claim 39, wherein the short-range communication protocol link comprises an infrared link.

42. The method of claim 39, wherein the receiving of a short-range communication protocol message in the first terminal device comprises receiving a health characteristic of a user of the first terminal device including a measured health characteristic within the data message.

43. The method of claim 42, wherein the measured health characteristic comprises at least one of monitoring a heart condition, respiration, blood pressure, temperature, and pulse.

44. The method of claim 1, wherein the second terminal device includes a database for maintaining health characteristic information of a user of the first terminal device.

45. A mobile terminal device, comprising:
a means for obtaining data to be synchronized;
a SyncML module for formatting the data to be synchronized into a SyncML format;
a means for inserting the formatted data to be synchronized into at least one messaging transport protocol message; and
a transmitter to transmit the at least one messaging transport protocol message to another terminal device.

46. The mobile terminal device of claim 45, wherein the means for obtaining the data to be synchronized comprises a formulating application providing an interface for a user of the mobile terminal device to input a content of the data to be synchronized.

47. The mobile terminal device of claim 46, wherein the mobile terminal further comprises:
a display for displaying to the user of the mobile terminal device a set of available selection options associated with formatting a SyncML message; and
a key set for allowing the user of the mobile terminal device to input preferred selection options and to input the content of the data to be synchronized.

48. The mobile terminal device of claim 45, wherein the means for obtaining the data to be synchronized comprises a receiver for receiving the data to be synchronized.

49. The mobile terminal device of claim 48, wherein the receiver for receiving the data comprises a short-range communication receiver.

50. The mobile terminal device of claim 49, wherein the short-range communication receiver comprises a Bluetooth receiver conforming the principles of Bluetooth technology.

51. The mobile terminal device of claim 49, wherein the short-range communication receiver comprises an infrared receiver.

52. The mobile terminal device of claim 45, wherein the at least one messaging transport protocol message comprises an SMS (Short Message Service) message.

53. The mobile terminal device of claim 45, wherein the at least one messaging transport protocol message comprises an MMS (Multimedia Message Service) message.

54. The mobile terminal device of claim 45, wherein the mobile terminal device comprises a mobile phone.

55. A medium, executable in a computer system, for synchronizing data between first and second terminal devices, comprising:
program instructions for obtaining data to be synchronized in the first terminal device;
program instructions for formatting the data to be synchronized into a synchronization format;
program instructions for inserting the formatted data to be synchronized into at least one messaging transport protocol message in the first terminal device including identifiers associated with the synchronization format; and
program instructions for transmitting the at least one messaging transport protocol message including identifiers associated with the synchronization format from the first terminal device to the second terminal device via a mobile network.

56. A system for synchronizing data between first and second terminal devices, comprising:
a first terminal having means for obtaining data to be synchronized and a short-range transceiver for transmitting the data to be synchronized via a short-range communication link;
an intermediate terminal device having a short-range transceiver for receiving said data to be synchronized, the intermediate terminal further comprising:
a module for formatting the data to be synchronized into a synchronization format;
means for inserting the formatted data to be synchronized into at least one messaging transport protocol message including identifiers associated with the synchronization format; and
a transmitter for transmitting the at least one messaging transport protocol message including identifiers associated with the synchronization format via a mobile network;
an intermediate gateway capable of receiving the at least one messaging transport protocol message and forwarding the data to be synchronized to a destination; and
a second terminal device capable of receiving the data to synchronized and executing the data to be synchronized.

57. The system of claim 56, wherein the first terminal comprises a health characteristic monitor device and the means for obtaining data to be synchronized comprises health-monitoring means.

58. The system of claim 47, wherein the health monitoring means comprises at least one of monitoring a heart condition, respiration, blood pressure, temperature, and pulse.

59. The system of claim 56, wherein the short-range transceiver comprises a Bluetooth transceiver conforming the principles of Bluetooth technology.

60. The system of claim 56, wherein the short-range transceiver comprises an infrared transceiver.

61. The system of claim 56, wherein the identifiers associated with the synchronization format includes at least one identifier associated with a SyncML format and wherein the data to be synchronized is formatted according to SyncML format.

62. The system of claim 56, wherein the at least one transmitted messaging transport protocol message includes at least one identifier associated with a beginning of a SyncML message.

63. The system of claim 56, wherein the at least one transmitted messaging transport protocol message includes at least one identifier associated with a continuation of a SyncML message.

64. The system of claim 56, wherein the at least one transmitted messaging transport protocol message includes at least one identifier associated with an ending of a SyncML message.

65. The system of claim 56, wherein the at least one transmitted messaging transport protocol message comprises an SMS (Short Message Service) message.

66. The system of claim 65, wherein the at least one transmitted SMS message comprises at least one compressed SMS message.

67. The system of claim 66, wherein the at least one compressed SMS message comprises a WBXML (Wireless Application Protocol Binary Extension Markup Language) coded message.

68. The system of claim 56, wherein the at least one transmitted messaging transport protocol message comprises an MMS (Multimedia Message Service) message.

69. The system of claim 56, wherein the intermediate terminal device comprises a mobile phone.

70. The system of claim 56, wherein the second terminal device comprises a server connected to the Internet.

71. The system of claim 70, wherein the server comprises a health characteristic database for maintaining health characteristic information of a user of the first terminal device.

72. The system of claim 70, wherein the intermediate gateway device further comprises:
means for storing the at least one received SMS;
means for stacking and stripping the at least one stored SMS message into a single SyncML message; and
means for formatting the single SyncML message into a TCP/IP format prior sending the message to the server.
